(19) United States
(12) Patent Application Publication
(10) Pub. No.: US 2012/0147227 A1
(43) Pub. Date: Jun. 14, 2012

(54) IMAGE PICKUP APPARATUS AND CONTROL METHOD THEREOF

(75) Inventors: Yuki Yoshimura, Tokyo (JP); Koichi Fukuda, Tokyo (JP); Hirohito Kai, Tokyo (JP); Yoshihito Tamaki, Yokohama-shi (JP)

(73) Assignee: CANON KABUSHIKI KAISHA, Tokyo (JP)

(21) Appl. No.: 13/312,365

(22) Filed: Dec. 6, 2011

(30) Foreign Application Priority Data
Dec. 13, 2010 (JP) 2010-276591
Nov. 22, 2011 (JP) 2011-255571

(51) Int. Cl. H04N 9/64

(52) U.S. Cl. 348/246; 348/E05.079

(57) ABSTRACT

The image pickup apparatus includes an image sensor having first and second pixels photoelectrically convert light fluxes passing through mutually different pupil areas, a correction calculating part calculating a correction parameter corresponding to a vignetting state of the light fluxes and performing a correction process using the correction parameter on first and second image signals produced from outputs from the first and second pixels, and a focus detection calculating part calculating a focus state of the image taking optical system based on a phase difference between the first and second image signals on which the correction process have been performed. The correction calculating part performs the correction process using a first correction parameter in the first focus detection area, and performs it using the first correction parameter in a second focus detection area close to the first focus detection area.

### BACKGROUND OF THE INVENTION

1. Field of the Invention

The present invention relates to an image pickup apparatus such as a digital still camera or a video camera, which detects a focus state of an image taking optical system by using an image sensor.

2. Description of the Related Art

Japanese Patent Laid-Open No. 04-267211 discloses an image pickup apparatus provided with an image sensor that is used for producing a captured image through image capturing of an object and in which a lot of pixels whose microlens and photoelectric converting part are relatively displaced are two-dimensionally arranged. The image pickup apparatuses disclosed in Japanese Patent Laid-Open No. 04-267211 produces a normal captured image by adding outputs from the pixels in which relative displacement directions of the microlens and the photoelectric converting part are opposite to each other. On the other hand, the image pickup apparatus detects a focus state of an image taking optical system (that is, performs focus detection) by calculating a phase difference between paired image signals produced from outputs of the above-mentioned pixels in which the relative displacement directions of the microlens and the photoelectric converting part are opposite to each other (the pixels are hereinafter referred to as “focus detection pixels”) and by calculating the focus state (defocus amount) from the phase difference.

However, in the focus detection, so-called vignetting that is a phenomenon in which part of a light flux traveling toward the focus detection pixel is blocked by the image taking optical system (including optical elements such as lenses and an aperture stop, and lens barrels holding them) is generated. In this case, in at least one of the paired image signals, lowering of signal level due to lowering of light amount, distortion of the image signal and unevenness of image signal intensity (that is, unevenness of light receiving sensitivities of the respective focus detection pixels, which is hereinafter referred to as “shading”). Such lowering of signal level, distortion of the image signal and shading due to the vignetting decreases a degree of coincidence of the paired image signals, which makes it impossible to perform good focus detection.

Thus, an image pickup apparatus disclosed in Japanese Patent Laid-Open No. 05-127074 changes an image signal correction value to be used for vignetting correction, which is prestored in a memory, according to an aperture ratio, an exit pupil position and a defocus amount. This image pickup apparatus corrects image signals by using the changed image signal correction value, and then performs focus detection with the corrected image signals.

Moreover, an image pickup apparatus disclosed in Japanese Patent Laid-Open No. 2008-085623 performs shading correction by using reference correction data produced based on shapes of lenses and installation position displacement correction data obtained from measurement of an installation position displacement of an image sensor and the lenses.

In addition, Japanese Patent No. 4011738 discloses an image pickup apparatus aiming to reduce calculation time for simultaneously performing focus detection in two or more focus detection areas among multiple focus detection areas provided in an image capturing area. This image pickup apparatus recognizes, when a moving object image pickup mode is selected, a main object position to efficiently select the two or more focus detection areas on the basis of information on the main object position. Specifically, the image pickup apparatus selects the two or more focus detection areas on a horizontal line and a vertical line passing through the main object position, and performs the focus detection in the selected focus detection areas.

It is desirable for the image pickup apparatus simultaneously performing the focus detection in the two or more focus detection areas as disclosed in Japanese Patent No. 4011738 to correct the image signals depending on the vignetting of the light flux traveling toward the focus detection pixels as with the image pickup apparatus disclosed in Japanese Patent Laid-Open Nos. 05-127074 and 2008-085623. However, it is necessary in this case that the image pickup apparatus calculate the image signal correction value for each focus detection area.

Moreover, in the image pickup apparatus to which an optical apparatus such as an interchangeable lens including an image taking optical system is detachably attachable, it is necessary to acquire, for each focus detection area, information required for calculating the image signal correction value from the optical apparatus through communication therewith. Such information acquisition increases calculation amount and the number of times of the communication, which increases time required for performing the focus detection.

### SUMMARY OF THE INVENTION

The present invention provides an image pickup apparatus capable of performing focus detection simultaneously in plural focus detection areas in a short time.

The present invention provides as one aspect thereof an image pickup apparatus including an image sensor configured to include first pixels and second pixels that respectively photoelectrically convert light fluxes passing through mutually different pupil areas of an exit pupil of an image taking optical system, a correction calculating part configured to calculate a correction parameter corresponding to a vignetting state of the light fluxes subjected to vignetting due to the image taking optical system, and configured to perform a correction process using the correction parameter on at least one of a first image signal produced from outputs from the first pixels and a second image signal produced from outputs from the second pixels, and a focus detection calculating part configured to calculate a focus state of the image taking optical system based on a phase difference between the first and second image signals on the at least one of which the correction process has been performed by the correction calculating part. The focus detection calculating part is configured to calculate the focus state in a first focus detection area selected from plural focus detection areas provided in an image capturing area, and configured to calculate the focus state in a second focus detection area included in a predetermined close area to the first focus detection area. The correction calculating part is configured to calculate a first correction parameter that is the correction parameter corresponding to the vignetting state in the first focus detection area, configured to perform the correction process using the first correction parameter in the first focus detection area, and configured to perform the correction process using the first correction parameter in the second focus detection area.

The present invention provides as another aspect thereof a method for controlling an image pickup apparatus provided with an image sensor configured to include first pixels and second pixels that respectively photoelectrically convert light fluxes passing through mutually different pupil areas of an exit pupil of an image taking optical system. The method includes a parameter calculating step of calculating a correction parameter corresponding to a vignetting state of the light fluxes subjected to vignetting due to the image taking optical system, a correction calculating step of performing a correction process using the correction parameter on at least one of a first image signal produced from outputs from the first pixels and a second image signal produced from outputs from the second pixels, and a focus detection calculating step of calculating a focus state of the image taking optical system based on a phase difference between the first and second image signals on the at least one of which the correction process has been performed in the correction calculating step. In the focus detection calculating step, the method calculates the focus state in a first focus detection area selected from plural focus detection areas provided in an image capturing area, and calculates the focus state in a second focus detection area included in a predetermined close area to the first focus detection area. In the correction calculating step, the method calculates a first correction parameter that is the correction parameter corresponding to the vignetting state in the first focus detection area, performs the correction process using the first correction parameter in the first focus detection area, and performs the correction process using the first correction parameter in the second focus detection area.

Further features of the present invention will become apparent from the following description of exemplary embodiments (with reference to the attached drawings).

### BRIEF DESCRIPTION OF THE DRAWINGS

FIG. 1 is a block diagram showing the configuration of an image pickup apparatus that is Embodiment 1 of the present invention.

FIG. 2 shows the structure of image pickup pixels provided in an image sensor that is used in the image pickup apparatus of Embodiment 1.

FIG. 3 shows the structure of focus detection pixels provided in the image sensor.

FIG. 4 shows pupil division in the image pickup apparatus of Embodiment 1.

FIG. 5 shows pupil intensity distributions of the focus detection pixels.

FIG. 6 shows pupil intensity distributions of the focus detection pixels located at a center of the image sensor.

FIG. 7 is a circuit diagram showing the configuration of a drive circuit for the image sensor.

FIG. 8 shows paired image signals obtained from the image sensor.

FIG. 9 shows an exterior of the image pickup apparatus of Embodiment 1.

FIG. 10 shows selection of a focus detection area in the image pickup apparatus of Embodiment 1.

FIG. 11 is a flowchart showing a focus detection process performed in the image pickup apparatus of Embodiment 1 (and Embodiment 2) when a minimum unit area is selected.

FIG. 12 is a flowchart showing a focus detection process performed in the image pickup apparatus of Embodiment 1 (and Embodiment 2) when an extended area is selected.

FIG. 13 shows pupil intensity distributions of the focus detection pixels when an image height of an exit pupil is high in an image pickup apparatus of Embodiment 2 of the present invention.

FIG. 14 shows pupil intensity distributions of the focus detection pixels when the image height of the exit pupil is high and a light flux passing area is narrower than that in FIG. 13 in Embodiment 2.

FIG. 15 shows a relationship between an aperture diameter D, an exit pupil distance Dp and an aperture value F in Embodiment 2.

FIG. 16 shows selection of the focus detection area in the image pickup apparatus of Embodiment 2.

### DESCRIPTION OF THE PREFERRED EMBODIMENTS

Exemplary embodiments of the present invention will hereinafter be described with reference to the accompanying drawings.

### Embodiment 1

### Configuration of Image Pickup Apparatus

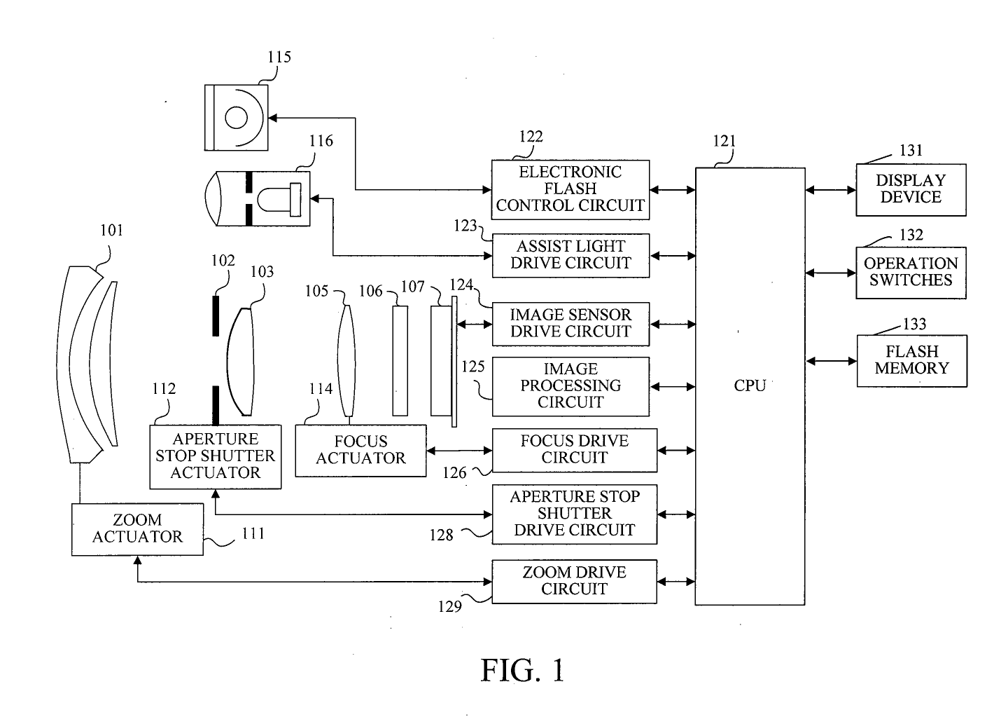

FIG. 1 shows the configuration of an image pickup apparatus that is a first embodiment (Embodiment 1) of the present invention. In FIG. 1, reference numeral 101 denotes a first lens group placed closest to an object (that is, placed at a most front side position) in an image taking lens as an image taking optical system. The first lens group 101 is held so as to be movable in a direction of an optical axis (hereinafter referred to as an “optical axis direction”).

Reference numeral 102 denotes an aperture stop shutter unit that changes its aperture diameter to adjust a light amount for exposure and to control an exposure time for still image capturing. Reference numeral 103 denotes a second lens group of the image taking lens. The aperture stop shutter unit 102 is movable integrally with the second lens group 103 in the optical axis direction. The first and second lens groups 101 and 102 are moved in the optical axis direction to perform variation of magnification (zoom operation).

Reference numeral 105 denotes a third lens group that is moved in the optical axis direction to perform focusing. Reference numeral 106 denotes an optical low-pass filter that is an optical element to reduce false color and moire in a captured image. Reference numeral 107 denotes an image sensor (image pickup element) constituted by a CMOS sensor, and its peripheral circuit. The image sensor 107 has m pixels (light-receiving elements) in a horizontal direction and n pixels in a vertical direction, and has primary color mosaic filters provided for the respective pixels and arranged in a Bayer arrangement, thereby constituting an on-chip two-dimensional single color sensor.

Reference numeral 111 denotes a zoom actuator that rotates a cam barrel (not shown) about the optical axis to move the first and second lens groups 101 and 102 in the optical axis direction for the zooming. Reference numeral 112 denotes an aperture stop shutter actuator that drives the aperture stop shutter 102 in open and close directions to cause it to perform the light amount adjustment (aperture stop operation) or the exposure time control (shutter operation). Reference numeral 114 denotes a focus actuator that moves the third lens group 105 in the optical axis direction to perform a focusing operation.

Reference numeral 115 denotes an electronic flash including a light source such as a xenon tube or an LED. Reference numeral 116 denotes an AF-assist light emitter that projects a mask image including a certain pattern onto the object through a projection lens. The projection of the mask image onto the object can improve focus detection performance when the object is dark or has a low contrast.

Reference numeral 121 denotes a CPU serving as a controller that governs control of operations of respective circuits described below and as a focus detection unit that detects a focus state of the image taking lens (in other words, performs focus detection). The CPU 121 as the focus detection unit serves as a correction calculating part and a focus detection calculating part. The CPU 121 includes a computing part, a ROM, a RAM, an A/D converter, a D/A converter and a communication interface circuit. The CPU 121 controls the operations of the respective circuits according to computer programs stored in the ROM, and executes a series of image capturing operations such as AF (including the focus detection and the focusing operation), image capturing, image processing and image recording.

Reference numeral 122 denotes an electronic flash control circuit that controls lighting of the electronic flash 115. Reference numeral 123 denotes an assist light drive circuit that controls lighting of the AF-assist light emitter 116. Reference numeral 124 denotes an image sensor drive circuit that drives the image sensor 107, A/D-converts pixel signals (image pickup signals) output from the image sensor 107, and transmits the converted digital image pickup signals to the camera CPU 121.

Reference numeral 125 denotes an image processing circuit that performs various image processing such as γ conversion and color interpolation on the digital image pickup signals from the image sensor 107 to produce a captured image (image data), and performs other processes on the image data such as JPEG compression. Reference numeral 126 denotes a focus drive circuit that controls drive of the focus actuator 114 in the focusing operation on the basis of a result of the focus detection. Reference numeral 128 denotes an aperture stop shutter drive circuit that controls drive of the aperture stop shutter actuator 112 to perform the aperture stop operation or the shutter operation. Reference numeral 129 denotes a zoom drive circuit that controls drive of the zoom actuator 111 in response to a user's zoom operation to perform the zoom operation.

Reference numeral 131 denotes a display device such as an LCD that displays information on an image capturing mode, a preview image before image capturing, information on the focus state and captured images. Reference numeral 132 denotes operation switches including a power switch, a release switch (image capturing trigger switch), a zoom operation switch and an image capturing mode selection switch. Reference numeral 133 denotes a detachable flash memory that records the captured images.

FIG. 9 shows an exterior (back face) of the image pickup apparatus of this embodiment. Reference numeral 201 denotes an optical viewfinder in FIG. 9. Reference numeral 202 denotes a back liquid crystal monitor that corresponds to the indicator 131 shown in FIG. 1. Reference numeral 203 denotes s a release button, which is a member to operate the above-mentioned release switch. Reference numeral 204 is a menu operation button, and reference numeral 205 denotes a focus detection area selection button.

### (Structure of Image Pickup Pixel)

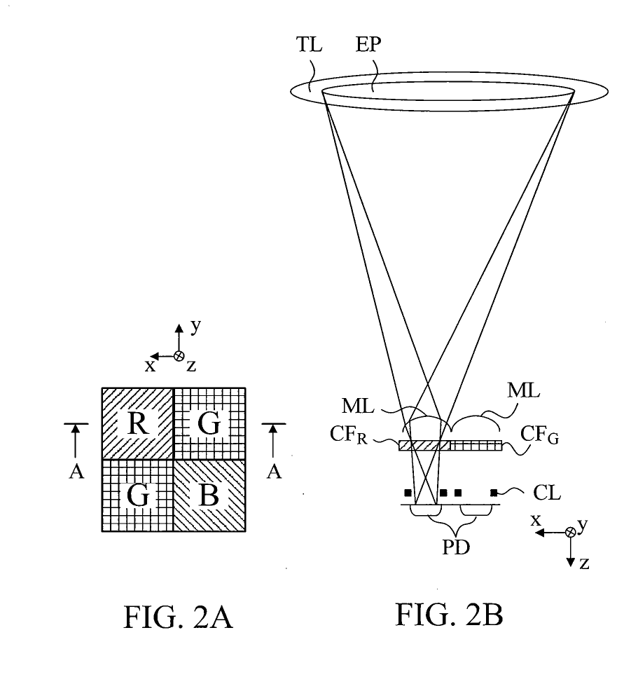

FIGS. 2A and 2B are an enlarged front view and a cross sectional view, respectively, that show the structure of an image pickup pixel unit among multiple image pickup pixels (first pixels) provided in the image sensor (C-MOS sensor) 107. FIGS. 2A and 2B show the image pickup pixel unit placed at a center of the image sensor 107.

In this embodiment, as shown in FIG. 2A, one image pickup pixel unit includes four (2 columns and 2 rows) pixels. Among the four pixels, two pixels arranged at two diagonal places are image pickup pixels having a spectral sensitivity to green (G), and other two pixels arranged at other two diagonal places are image pickup pixels having spectral sensitivities to red (R) and blue (blue). The pixels having the spectral sensitivities to G, R and B are hereinafter respectively referred to as “a G pixel”, “an R pixel” and “a B pixel”. Such pixel arrangement is known as the above-mentioned Bayer arrangement. In a lot of such 2 columns and 2 rows image pickup pixels, focus detection pixels described later are dispersedly (discretely) arranged according to a predetermined arrangement rule.

FIG. 2B shows a cross section cut along a line A-A in FIG. 2A. Reference character ML denotes an on-chip microlens placed in a most-front layer of each pixel. Reference character CF_{R} denotes an R (red) color filter, and reference character CF_{G} denotes a G (green) color filter. Reference character PD denotes a photoelectric conversion part of the CMOS sensor. Reference character CL denotes a wiring layer in which signal lines to transmit various signals in the CMOS sensor are formed. Reference character TL denotes the image taking optical system.

The on-chip microlens ML and the photoelectric conversion part PD of the image pickup pixel are configured so as to take in a light flux that has passed through the image taking optical system TL as effectively as possible. In other words, an exit pupil EP of the image taking optical system TL and the photoelectric conversion part PD are arranged in a conjugate relationship with each other by the microlens ML, and an effective area of the photoelectric conversion part PD is set to be large. The R pixel, the G pixel and the B pixel have an identical structure to each other. Although FIG. 2B shows the light flux entering the R pixel, light fluxes enter the G and B pixels similarly to that entering the R pixel. Therefore, the exit pupil EP corresponding to the RGB image pickup pixels has a large diameter in order to efficiently take in the light flux from the object, which improves the S/N ratio of the image signal.

### (Structure of Focus Detection Pixel)

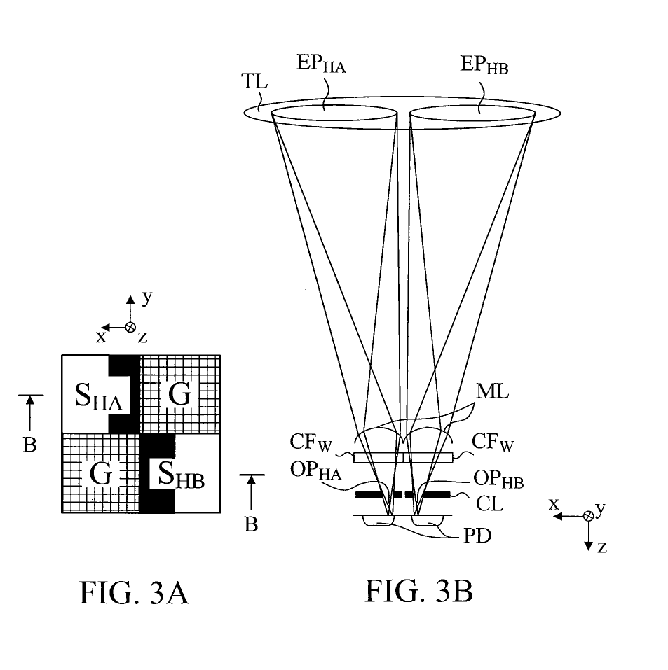

FIGS. 3A and 3B are an enlarged front view and a cross sectional view, respectively, that show the structure of a focus detection pixel unit among plural focus detection pixels (second pixels) regularly and dispersedly arranged in the image sensor 107. FIGS. 3A and 3B show the focus detection pixel unit placed at the center of the image sensor 107.

In this embodiment, as shown in FIG. 3A, one focus detection pixel unit includes four (2 columns and 2 rows) pixels. Among the four pixels, two pixels are allocated as the focus detection pixels that receive light fluxes passing through areas (divided areas) mutually different in an x direction, of the exit pupil of the image taking lens TL. The x direction is also referred to as “a pupil division direction”, and the divided areas are also referred to as “pupil areas”.

Since a human image recognition characteristic is sensitive to luminance information, defect of the G pixel easily causes humans to recognize image quality degradation. Therefore, the G pixel is a main component of the luminance information. On the other hand, though the R and B pixels provide color information, the humans are insensitive to the color information, and therefore defect of the R and B pixels hardly causes the humans to recognize the image quality degradation.

Thus, in this embodiment, the focus detection pixel units each including the focus detection pixels are dispersedly arranged in the multiple image pickup pixels, and, in each focus detection pixel unit, the G pixels are remained as the image pickup pixels and the focus detection pixels are arranged at positions corresponds to those of the R and B pixels. In FIG. 3A, the focus detection pixels are shown by S_{HA} and S_{HB}.

FIG. 3B shows a cross section cut along a line B-B in FIG. 3A. The microlens ML and the photoelectric conversion part PD have same structures as those in the image pickup pixel shown in FIG. 2B.

In this embodiment, since signals from the focus detection pixels are not used for producing a captured image, a transparent film (white film) CF_{W} is placed instead of a color separation color filter. Moreover, since the focus detection pixel divides the exit pupil, an aperture of the wiring layer CL is displaced with respect to a centerline of the microlens ML in the x direction.

Specifically, in FIG. 3B, since an aperture OP_{HA} of the focus detection pixel S_{HA} is displaced in a −x direction, and thus the photoelectric conversion part PD of the focus detection pixel S_{HA} receives a light flux passing through a left side (+x side) pupil area EP_{HA} of the image taking lens TL. On the other hand, since an aperture OP_{HB} of the focus detection pixel S_{HB} is displaced in a +x direction, and thus the photoelectric conversion part PD of the focus detection pixel S_{HB} receives a light flux passing through a right side (−x side) pupil area EP_{HB} of the image taking lens TL.

In the following description, the plural focus detection pixels S_{HA} regularly arranged in the x direction are also referred to as “a focus detection pixel group S_{HA}”, and an image signal acquired by using the focus detection pixel group S_{HA} is referred to as “an image signal (first image signal) ImgA”. Furthermore, the plural focus detection pixels S_{HB} regularly arranged in the x direction are also referred to as “a focus detection pixel group S_{HB}”, and an image signal acquired by using the focus detection pixel group S_{HB} is referred to as “an image signal (second image signal) ImgB”.

Using a phase difference that is a relative shift amount between the image signals ImgA and ImgB calculated by performing correlation calculation on these image signals ImgA and ImgB enables calculation of a defocus amount showing the focus state of the image taking lens. Such a focus detection method is called a phase difference detection method. Moving the third lens group 103 according to the calculated defocus amount enables acquisition of an in-focus state.

### (Pupil Division by Focus Detection Pixels)

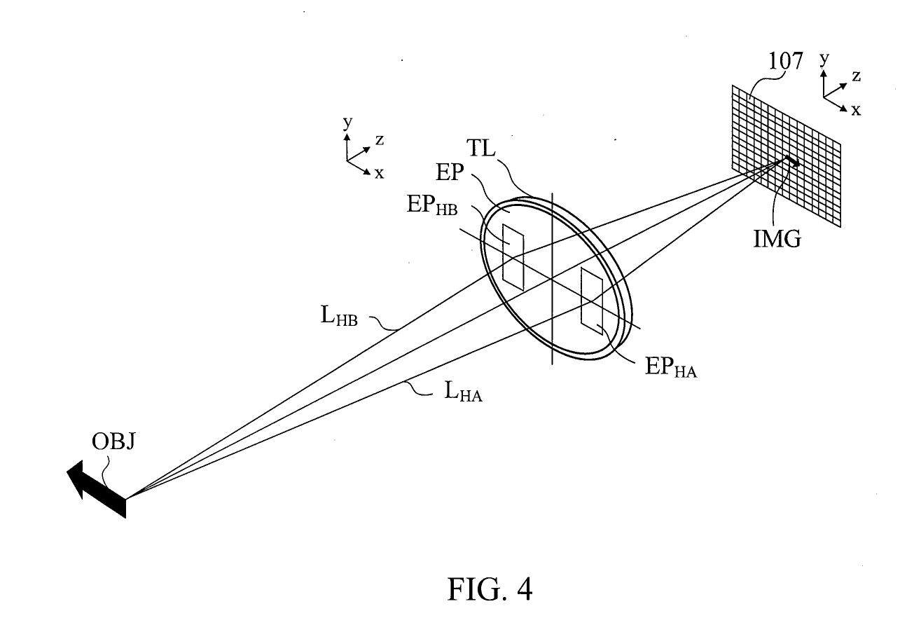

FIG. 4 shows pupil division by the focus detection pixels in this embodiment. Reference character TL denotes the image taking lens, reference number 107 denotes the image sensor, reference character OBJ denotes an object, and reference character IMG denotes an object image. The image pickup pixels receive the light flux passing through an entire area of the exit pupil EP of the image taking lens TL, as shown in FIG. 2B. On the other hand, the focus detection pixels have a pupil division function of performing the pupil division in the x direction, as shown in FIG. 3B.

Specifically, the focus detection pixel S_{HA} receives the light flux L_{HA} passing through the +x side pupil area EP_{HA}, and the focus detection pixel S_{HB} receives the light flux L_{HB} passing through the −x side pupil area EP_{HB}. Dispersed arrangement of these focus detection pixels S_{HA} and S_{HB} over the entire image sensor 107 enables the focus detection over an entire image capturing area.

Although the above description has been made of the configuration to perform the focus detection for an object having a luminance distribution in the x direction, using a similar configuration thereto in the y direction makes it possible to perform the focus detection for an object having a luminance distribution in the y direction.

(Pupil Intensity Distribution and Line Spread Function when Vignetting is not Generated)

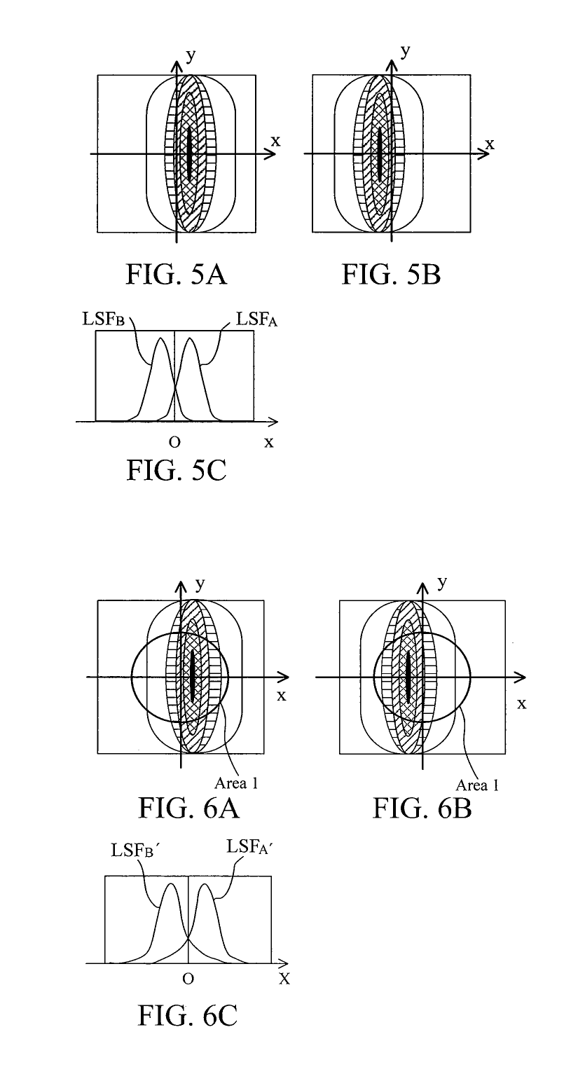

In the following description, an intensity distribution of the light flux in an exit pupil plane is hereinafter referred to as “a pupil intensity distribution”. FIGS. 5A, 5B and 5C show the pupil intensity distributions of the focus detection pixels and line spread functions obtained from the pupil intensity distributions in an ideal case where no vignetting of the light flux is generated by the image taking lens (image taking optical system).

FIG. 5A shows the pupil intensity distribution of the focus detection pixel S_{HA}, and FIG. 5B shows the pupil intensity distribution of the focus detection pixel S_{HB}. A direction in which an x axis extends (hereinafter referred to as “an x axis direction”) and a direction in which a y axis extends (hereinafter referred to as “a y axis direction”) in FIGS. 5A and 5B respectively correspond to the x direction and the y direction shown in FIG. 4. In FIGS. 5A and 5B, in each oval light reception area, the intensity increases from its outside toward its inside.

FIG. 3A has showed the pupil area EP_{HA} corresponding to the focus detection pixel S_{HA} and the pupil area EP_{HB} corresponding to the focus detection pixel S_{HB} separately from each other. However, in reality as shown in FIGS. 5A and 5B, the pupil areas EP_{HA} and EP_{HB} partially overlap each other because the light fluxes entering the focus detection pixels S_{HA} and S_{HB} are spread due to diffraction caused by the apertures OP_{HA} and OP_{HB}.

FIG. 5C shows the line spread functions LSF_{A} and LSF_{B} corresponding to the focus detection pixels S_{HA} and S_{HB}. The line spread functions LSF_{A} and LSF_{B} in this figure are obtained by y-direction projection of the pupil intensity distributions shown in FIGS. 5A and 5B, respectively. A horizontal axis corresponds to the x axis in FIGS. 5A and 5B, and a vertical axis shows intensity of the line spread function. An origin O corresponds to a position of the optical axis of the image taking lens.

A so-called point spread function, that is, an intensity distribution of a point image formed on an image-forming surface by a light flux emitted from a point light source and passing through an exit pupil of an optical system, can be considered as reduced projection of a pupil intensity distribution having a shape of the exit pupil, when the optical system has no aberration. A line spread function is projection of the point spread function, so that the projection of the pupil intensity distribution corresponds to the line spread function.

As shown in FIG. 5C, in the focus detection pixels located at the center of the image sensor 107, the line spread functions LSF_{A} and LSF_{B} are symmetric with each other with respect to the optical axis. In other words, shapes of optical images formed on the photoelectric conversion parts PD in the focus detection pixels S_{HA} and S_{HB} approximately coincide with each other. Moreover, each of the line spread functions LSF_{A} and LSF_{B} has an approximately symmetric shape in the x axis direction with respect to its centroid position as a symmetry center in the x axis direction.

(Pupil Intensity Distribution and Line Spread Function when Vignetting is Generated)

FIGS. 6A, 6B and 6C show the pupil intensity distributions of the focus detection pixels and the line spread function obtained from the pupil intensity distributions in a case where vignetting of the light flux is generated by the image taking lens (image taking optical system). The “image taking lens (image taking optical system)” includes not only the first, second and third lens groups 101, 103 and 105, the aperture stop shutter unit 102 and the optical element such as the low-pass filter 106, but also holding members such as lens barrels that hold them and members blocking the light flux.

FIG. 6A shows the pupil intensity distribution of the focus detection pixel S_{HA}, and FIG. 6B shows the pupil intensity distribution of the focus detection pixel S_{HB}. An x axis direction and a y axis direction in FIGS. 6A and 6B also respectively correspond to the x direction and the y direction shown in FIG. 4. Also in FIGS. 6A and 6B, in each oval light reception area, the intensity increases from its outside toward its inside.

In the light flux forming the pupil intensity distributions of the focus detection pixels S_{HA} and S_{HB} shown in FIGS. 6A and 6B, only light fluxes passing through areas shown by Areal are received by the focus detection pixels S_{HA} and S_{HB}. In other words, light fluxes outside the areas Areal are not received by the focus detection pixels S_{HA} and S_{HB} due to the vignetting by the image taking lens.

FIG. 6C shows the line spread functions LSF_{A}′ and LSF_{B}′ corresponding to the focus detection pixels S_{HA} and S_{HB}. The line spread functions LSF_{A}′ and LSF_{B}′ in this figure are also obtained by y-direction projection of the pupil intensity distributions shown in FIGS. 6A and 6B, respectively. A horizontal axis corresponds to the x axis in FIGS. 6A and 6B, and a vertical axis shows intensity of the line spread function. An origin O corresponds to the position of the optical axis of the image taking lens.

As shown in FIG. 6C, in the focus detection pixels located at the center of the image sensor 107, the line spread functions LSF_{A}′ and LSF_{B}′ are approximately symmetric with each other with respect to the optical axis. However, the pupil intensity distributions of the focus detection pixels S_{HA} and S_{HB} are partially clipped by the areas Areal that limit passage of the light fluxes (that is, the vignetting by the areas Areal). Therefore, each of the line spread functions LSF_{A}′ and LSF_{B}′ has an asymmetric shape in the x axis direction with respect to its centroid position in the x axis direction. Thus, a degree of coincidence of shapes of the optical images formed on the photoelectric conversion parts PD of the focus detection pixels S_{HA} and S_{HB} is decreased.

### (Configuration for Focus Detection)

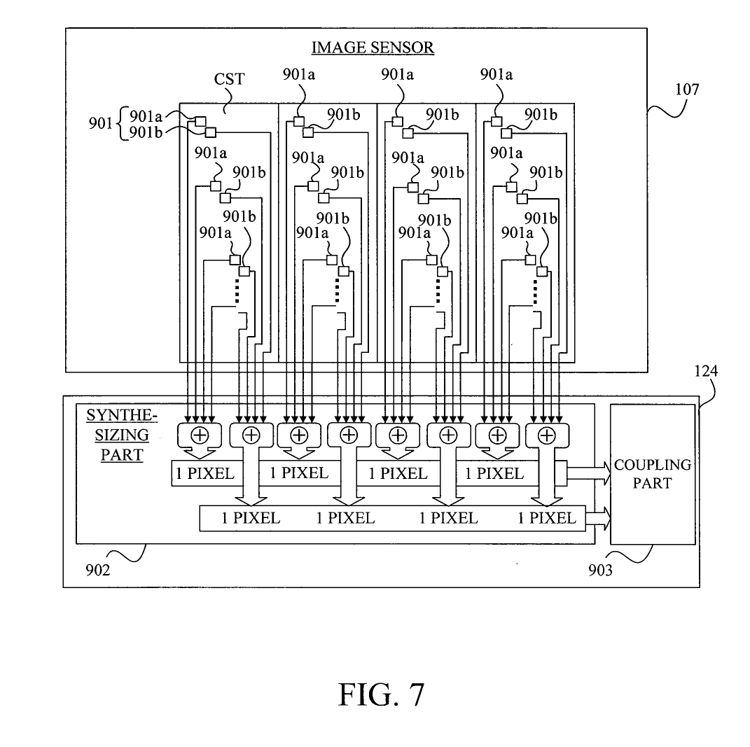

FIG. 7 shows, of the image sensor 107 and the image sensor drive circuit 124 shown in FIG. 1, a partial configuration relating to the focus detection. In FIG. 7, an A/D converter is omitted.

The image sensor 107 includes plural focus detection pixel units 901 each including a focus detection pixel 901a corresponding to the focus detection pixel S_{HA} shown in FIG. 3A and a focus detection pixel 901b corresponding to the focus detection pixel S_{HB} shown in the same figure. Moreover, the image sensor 107 includes the plural image pickup pixels for photoelectrically converting an object image formed by the image taking lens.

The image sensor drive circuit 124 includes a synthesizing part 902 and a coupling part 903. The image sensor drive circuit 124 divides an image pickup surface of the image sensor 107 into plural sections (areas) CST such that each section CTS includes two or more focus detection pixel units 901. The image sensor drive circuit 124 can arbitrarily change the size, the arrangement and the number of the sections CTS.

The synthesizing part 902 performs, in each divided section CST of the image sensor 107, a process to synthesize output signals from the focus detection pixels 901a to produce a first synthesized signal corresponding to one pixel signal. Moreover, the synthesizing part 902 performs, in each divided section CST, a process to synthesize output signals from the focus detection pixels 901b to produce a second synthesized signal corresponding to one pixel signal.

The coupling part 903 performs a process for coupling the first synthesized signals produced in the plural sections CST to produce a first coupled signal, and performs a process for coupling the second synthesized signals produced in the plural sections CST to produce a second coupled signal.

The first synthesized signals each of which is produced from the output signals of the focus detection pixels 901a in each section CTS are thus coupled over the plural sections CST, thereby obtaining the first coupled signal corresponding to the image signal ImgA. Similarly, the second synthesized signals each of which is produced from the output signals of the focus detection pixels 901b in each section CTS are thus coupled over the plural sections CST, thereby obtaining the second coupled signal corresponding to the image signal ImgB.

Then, the CPU 121 performs correlation calculation on the first and second coupled signals (image signals ImgA and ImgB) to calculate a phase difference therebetween, and calculates the defocus amount of the image taking lens on the basis of the phase difference. Thus, this embodiment synthesizes the output signals from the focus detection pixels provided in each section CST, which enables sufficiently good detection of an object luminance distribution even if a luminance at each focus detection pixel is low.

### (Correction Process of Image Signals)

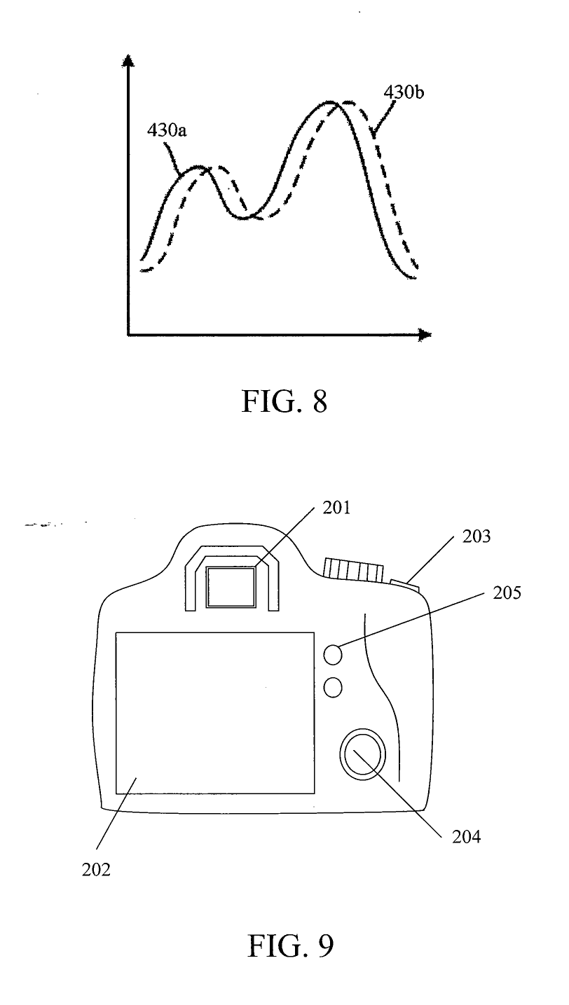

FIG. 8 shows paired image signals (ImgA and ImgB) 430a and 430b that are produced by the focus detection pixel units 901, the synthesizing part 902 and the coupling part 903 shown in FIG. 7 and then sent to the CPU 121. In FIG. 8, a horizontal axis shows an arrangement direction of the focus detection pixels whose output signals are coupled by the coupling part 903, and a vertical axis shows intensity of the image signal. The image signal 430a corresponds to the focus detection pixels 901a, and the image signal 430b corresponds to the focus detection pixels 901b.

FIG. 8 shows a defocus state of the image taking lens where the image signal 430a is displaced to left in the figure and the image signal 430b is displaced to right in the figure. Calculation of the phase difference that is the shift amount of these image signals 430a and 430b by the correlation calculation enables calculation of the defocus amount and a defocus direction of the image taking lens.

In this embodiment, as shown in FIG. 6C, the line spread function of each focus detection pixel is asymmetric with respect to its centroid due to the vignetting of the light flux, so that the image signal obtained by the focus detection pixels also has asymmetry. That is, at least one of the paired image signals includes signal level lowering or distortion due to decrease of the light amount. As a result, the degree of coincidence between the paired image signals is decreased.

In the focus detection by the phase difference detection method, such a decrease of the degree of coincidence between the paired image signals makes it impossible to accurately calculate the phase difference, which decreases calculation accuracy of the defocus amount, that is, in-focus accuracy.

Thus, this embodiment calculates a light amount correction value and a distortion correction value that are correction parameters for correcting the light amount (signal level) and the distortion of the produced image signals, and performs a correction process on the image signals by using these correction values. This correction process enables improvement of the degree of coincidence between the paired image signals, which makes it possible to accurately calculate the phase difference.

### (Focus Detection Process Including Correction Process)

In the image pickup apparatus of this embodiment, one of an operation of the focus detection area selection button 205 shown in FIG. 9 and a selection process of the CPU 121 selects a position of the focus detection area where the focus detection is actually performed among the multiple focus detection areas provided over the entire image capturing area. Moreover, the focus detection area where the focus detection is actually performed can be selected from a minimum unit area (one focus detection area) and an extended area (plural focus detection areas) through the operation of the focus detection area selection button 205.

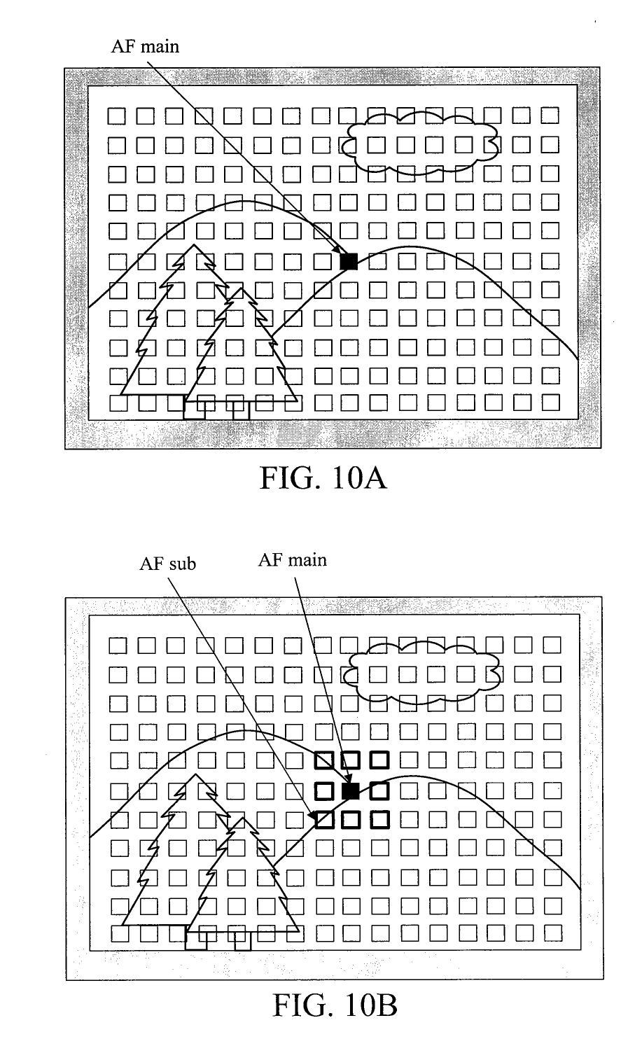

When the minimum unit area is selected, one focus detection area AFmain selected in response to the operation of the focus detection area selection button 205 or by the selection process of the CPU121 is set as the focus detection area where the focus detection is actually performed, as shown in FIG. 10A. A mode in which the focus detection is performed in the minimum unit area is referred to as “a minimum unit area focus detection mode”.

On the other hand, when the extended area is selected, the above-mentioned selected one focus detection area AFmain and plural (two or more) focus detection areas AFsub adjacent to the focus detection area AFmain (that is, arranged around the focus detection area AFmain) are set as the focus detection areas where the focus detection is actually performed, as shown in FIG. 10B. In other words, this embodiment sets, in addition to the focus detection area AFmain where the focus detection is mainly performed, the focus detection areas AFsub which are arranged in a predetermined close area to the focus detection area AFmain (adjacent area thereto or surrounding area) and where the focus detection is performed as subsidiary focus detection. When the extended area is selected, the focus detection area AFmain corresponds to a first focus detection area, and the focus detection area AFsub corresponds to a second focus detection area. A mode in which the focus detection is performed in the extended area is referred to as “an extended area focus detection mode”.

This embodiment uses, in the extended area focus detection mode, the correction parameters for the image signals obtained in the focus detection area AFmain also as correction parameters for the image signals obtained in the focus detection area AFsub.

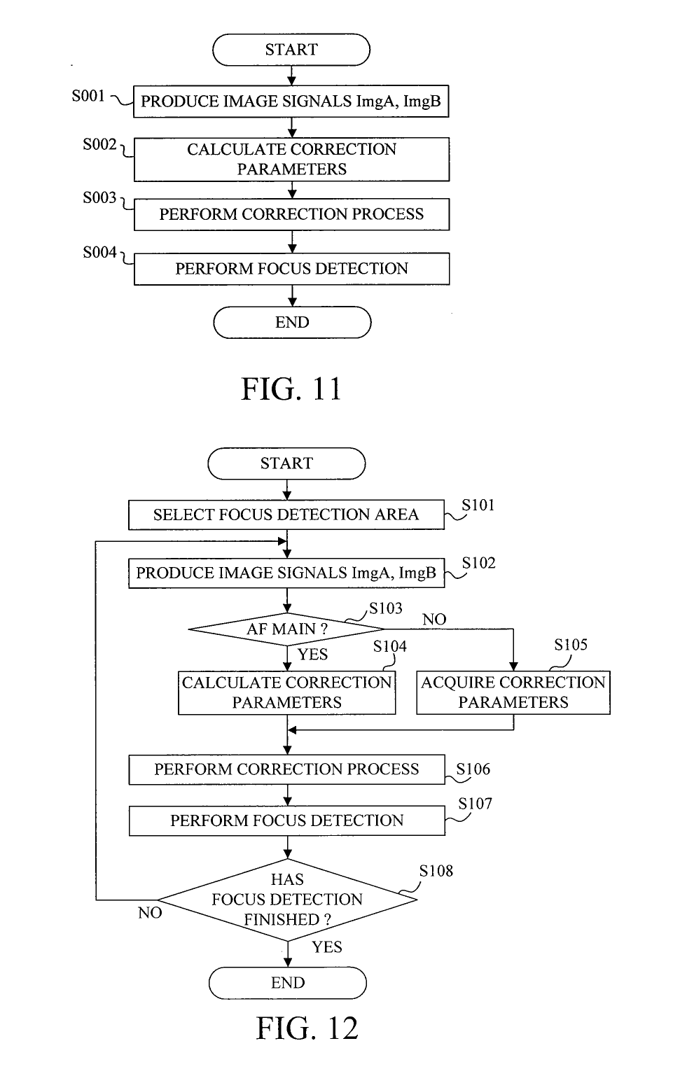

Next, description will be made of the focus detection process (that is, a control method for the image pickup apparatus) including the correction process with reference to flowcharts shown in FIGS. 11 and 12, the process being executed by the CPU 121 according to a computer program as a focus detection program.

First of all, description will be made of the focus detection process in the minimum unit area focus detection mode with reference to the flowchart shown in FIG. 11.

At step S001, the CPU 121 produces the paired image signals ImgA and ImgB by using the output signals from the focus detection pixels corresponding to the focus detection area AFmain selected in response to the operation of focus detection area selection button 205 or by the selection process of the CPU 121.

At step S002, the CPU 121 calculates the correction parameters (light amount correction value and distortion correction value) to be used in light amount correction and distortion correction for the paired image signals ImgA and ImgB.

Specifically, the CPU 121 first acquires lens information necessary to confirm a vignetting state of the light flux due to the image taking lens (image taking optical system) from the image taking lens. The lens information includes information on a size, an optical axis direction position and aberration of each lens group, and information on an aperture diameter of the aperture stop shutter unit 102. The lens information can also be said as information on the vignetting state of the light flux due to the image taking lens (image taking optical system).

The “acquisition of the lens information” means that, when the image pickup apparatus is a lens-interchangeable image pickup apparatus, reception of the lens information from an interchangeable lens as an attached optical apparatus through communication therewith. On the other hand, when the image pickup apparatus is a lens-integrated image pickup apparatus, the “acquisition of the lens information” means that reading of the lens information from a memory prestoring it and from a position detector detecting the optical axis direction position of the lens group.

The CPU 121 predicts a vignetting state of the paired image signals ImgA and ImgB produced at step S001 by using the lens information thus acquired and the pupil intensity distribution for each focus detection pixel stored in the ROM of the CPU 121. Then, the CPU 121 calculates the light amount correction value that is the correction parameter for correcting the signal levels of the paired image signals ImgA and ImgB.

Next, the CPU 121 calculates the phase difference between the paired image signals ImgA and ImgB produced at step S001, and calculates a provisional defocus amount on the basis of the phase difference. In addition, the CPU 121 calculates the distortion correction value that is the correction parameter for correcting the distortion of the paired image signals ImgA and ImgB by using the provisional defocus amount, the lens information and the pupil intensity distribution. Thus, the correction parameters for the focus detection area AFmain corresponding to the vignetting state of the light flux in the focus detection area AFmain due to the image taking lens (image taking optical system) are calculated.

Next, at step S003, the CPU 121 performs the correction process on the paired image signals ImgA and ImgB produced at step S001, by using the correction parameters calculated at step S002.

Specifically, the CPU 121 first performs the light amount correction using the light amount correction value on the image signals ImgA and ImgB to produce (calculate) light amount corrected image signals ImgA′ and ImgB′. Thereafter, the CPU 121 performs the distortion correction using the distortion correction value on the light amount corrected image signals ImgA′ and ImgB′ to produce (calculate) distortion corrected image signals ImgA″ and ImgB″.

Next, at step S004, the CPU 121 performs the correlation calculation on the distortion corrected image signals ImgA″ and ImgB″ produced at step S003 to calculate the phase difference therebetween. Then, the CPU 121 calculates the defocus amount of the image taking lens on the basis of the phase difference. Thus, the focus detection process is ended.

The CPU 121 calculates, from the calculated defocus amount, a movement amount of the third lens group 105 to obtain an in-focus state, and then drives the focus actuator 114 to move the third lens group 105 by the calculated movement amount. Thus, autofocus (AF) is completed.

Next, description will be made of the focus detection process when the extended area focus detection mode is selected, with reference to the flowchart shown in FIG. 12.

At step S101, the CPU 121 selects the focus detection area AFmain in response to the operation of the focus detection area selection button 205 or by the selection process of the CPU 121, and then selects the plural focus detection areas AFsub adjacent to the focus detection area AFmain. The number of the selected focus detection areas AFsub is changed according to the position of the focus detection area AFmain.

For example, when the focus detection area AFmain is located at the vicinity of the center of the image capturing area, the number of the focus detection areas AFsub adjacent to the focus detection area AFmain in its surroundings is eight. When the focus detection area AFmain is located at an edge closest to a long side or a short side of the image capturing area, the number of the focus detection areas AFsub is five. In addition, when the focus detection area AFmain is located at a corner of the image capturing area, the number of the focus detection areas AFsub is three.

At step S102, the CPU 121 produces the paired image signals ImgA and ImgB by using the output signals from the focus detection pixels corresponding to one focus detection area among the focus detection areas AFmain and AFsub.

At step S103, the CPU 121 determines whether the focus detection area in which the paired image signals ImgA and ImgB have been produced at step S102 is the focus detection area AFmain or the focus detection area AFsub.

If determining that the focus detection area in which the paired image signals ImgA and ImgB have been produced is the focus detection area AFmain, the CPU 121 proceeds to step S104 (parameter calculating step). At step S104, the CPU 121 calculates the correction parameters (light amount correction value and distortion correction value) for performing the light amount correction and the distortion correction on the paired image signals ImgA and ImgB obtained in the focus detection area AFmain. The correction parameters are calculated by the same method as that described at step S002 in FIG. 11.

Specifically, the CPU 121 first acquires the lens information necessary to confirm the vignetting state of the light flux due to the image taking lens from the image taking lens. Next, the CPU 121 predicts the vignetting state of the paired image signals ImgA and ImgB produced at step S102 by using the lens information and the pupil intensity distribution for each focus detection pixel stored in the ROM of the CPU 121. Then, the CPU 121 calculates the light amount correction value that is the correction parameter for correcting the signal levels of the paired image signals ImgA and ImgB.

Moreover, the CPU 121 calculates the phase difference between the paired image signals ImgA and ImgB produced at step S102, and calculates a provisional defocus amount on the basis of the phase difference. In addition, the CPU 121 calculates the distortion correction value that is the correction parameter for correcting the distortion of the paired image signals ImgA and ImgB by using the provisional defocus amount, the lens information and the pupil intensity distribution. Thus, the correction parameters (first correction parameters) for the focus detection area AFmain corresponding to the vignetting state of the light flux in the focus detection area AFmain due to the image taking lens (image taking optical system) are calculated.

On the other hand, if determining that the focus detection area in which the paired image signals ImgA and ImgB have been produced is the focus detection area AFsub at step S103, the CPU 121 proceeds to step S105. At step S105, the CPU 121 acquires the correction parameters (light amount correction value and distortion correction value) calculated at step S104 for the focus detection area AFmain. In other words, the correction parameters for the focus detection area AFmain is used as the correction parameters for the focus detection area AFsub without calculating the correction parameters for the focus detection area AFsub. This is because the focus detection area AFsub is adjacent to the focus detection area AFmain, and therefore a difference between the vignetting states due to the image taking lens in the focus detection area AFsub and the focus detection area AFmain is generally small.

At step S106, the CPU 121 performs the correction process on the paired image signals ImgA and ImgB produced at step S102, by using the correction parameters calculated at step S104 or obtained at step S105. Specifically, the CPU 121 performs the same correction process as that described at step S003 in FIG. 11 on the paired image signals ImgA and ImgB to produce (calculate) the light amount corrected image signals ImgA′ and ImgB′, and then to produce (calculate) the distortion corrected image signals ImgA″ and ImgB″.

Next, at step S107, the CPU 121 performs the correlation calculation on the distortion corrected image signals ImgA″ and ImgB″ produced at step S106 to calculate the phase difference therebetween. Thereafter, the CPU 121 calculates the defocus amount of the image taking lens on the basis of the phase difference.

Next, at step S108, the CPU 121 determines whether or not the focus detection has finished in the focus detection area AFmain and all of the plural focus detection areas AFsub. If determining that the focus detection in all of the focus detection areas AFmain and AFsub has not finished yet, the CPU 121 returns to step S102 to perform the focus detection in the focus detection area where the focus detection has not finished yet. If determining that the focus detection in all of the focus detection areas AFmain and AFsub has finished, the CPU 121 ends the focus detection process.

The CPU 121 calculates, from the calculated defocus amount, the movement amount of the third lens group 105 to obtain an in-focus state, and then drives the focus actuator 114 to move the third lens group 105 by the calculated movement amount. Thus, the autofocus is completed.

### Embodiment 2

Description of a second embodiment (Embodiment 2) of the present invention will be made. Embodiment 1 has described the case of performing the correction process with the light amount correction value and the distortion correction value as the correction parameters to correct the lowered level (light amount) and distortion of the image signals caused by the vignetting of the light flux due to the image taking lens. On the other hand, Embodiment 2 performs a correction process with a shading correction value as a correction parameter to correct shading of the image signals caused by the vignetting of the light flux due to the image taking lens.

The internal and external configurations of the image pickup apparatus in this embodiment are the same as those shown in FIGS. 1 and 9.

### (Calculation of Shading Correction Value)

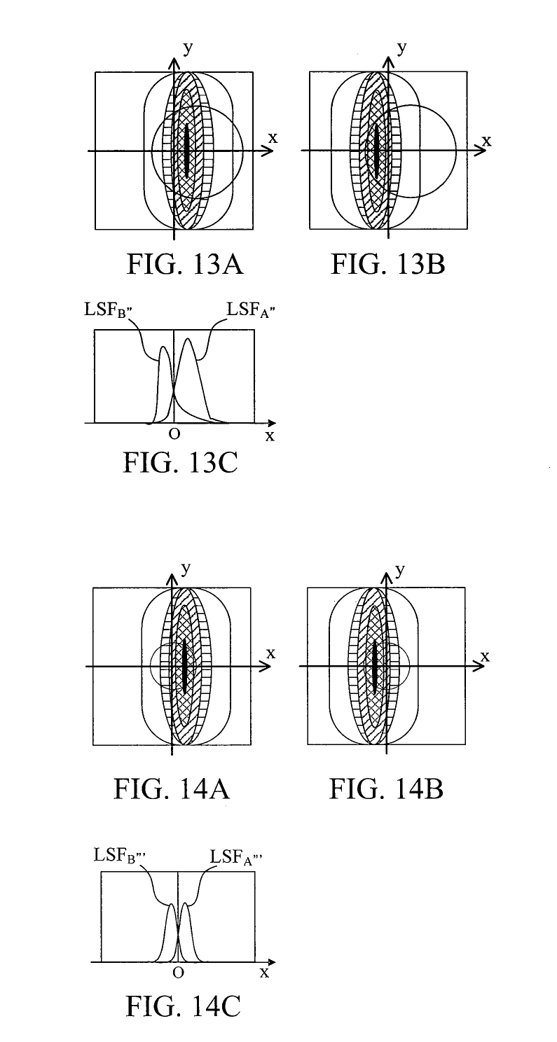

FIGS. 13A and 13B respectively shows pupil intensity distributions of the focus detection pixels S_{HA} and S_{HB} shown in FIG. 3A when the area Areal shown in FIGS. 6A and 6B shifts in a +x direction to a position where an image height is high, that is, when an image height of the exit pupil is high. In FIGS. 13A and 13B, in each oval light reception area, the intensity increases from its outside toward its inside. In the light flux forming the pupil intensity distributions of the focus detection pixels S_{HA} and S_{HB} shown in FIGS. 13A and 13B, only light fluxes passing through areas shown by Areal are received by the focus detection pixels S_{HA} and S_{HB}. In other words, light fluxes outside the areas Areal are not received by the focus detection pixels S_{HA} and S_{HB} due to the vignetting by the image taking lens.

FIG. 13C shows the line spread functions LSF_{A}″ and LSF_{B}″ corresponding to the focus detection pixels S_{HA} and S_{HB}. The line spread functions LSF_{A}″ and LSF_{B}″ in this figure are obtained by y-direction projection of the pupil intensity distributions shown in FIGS. 13A and 13B, respectively. A horizontal axis corresponds to the x axis in FIGS. 13A and 13B, and a vertical axis shows intensity of the line spread function.

FIGS. 14A and 14B also respectively show pupil intensity distributions of the focus detection pixels S_{HA} and S_{HB} shown in FIG. 3A when the area Areal shown in FIGS. 6A and 6B shifts in the +x axis direction to the position where the image height is high. However, FIGS. 14A and 14B show the pupil intensity distributions when the area Areal is narrower than that shown in FIGS. 13A and 13B.

Also in FIGS. 14A and 14B, in each oval light reception area, increases from its outside toward its inside. In the light flux forming the pupil intensity distributions of the focus detection pixels S_{HA} and S_{HB} shown in FIGS. 14A and 14B, only light fluxes passing through areas shown by Areal are received by the focus detection pixels S_{HA} and S_{HB}. In other words, light fluxes outside the areas Areal are not received by the focus detection pixels S_{HA} and S_{HB} due to the vignetting by the image taking lens.

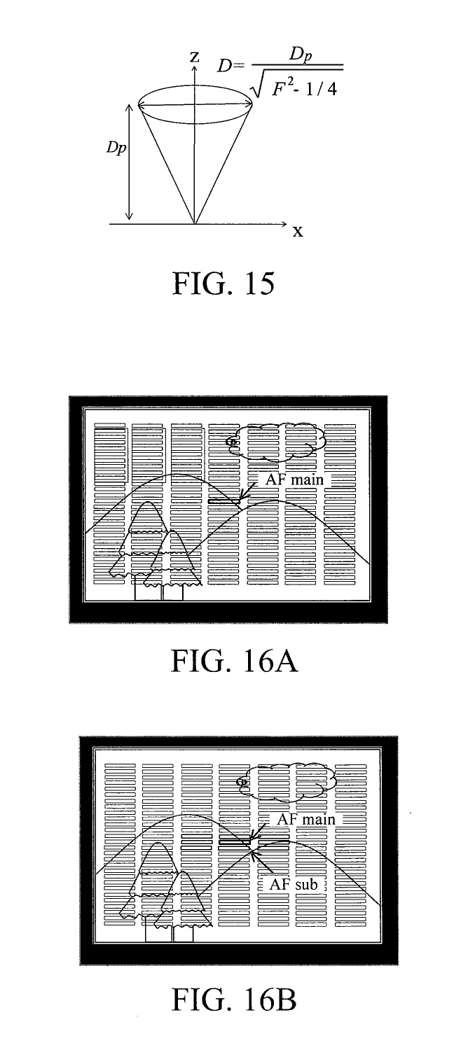

FIG. 14C shows the line spread functions LSF_{A}″′ and LSF_{B}″′ corresponding to the focus detection pixels S_{HA} and S_{HB}. The line spread functions LSF_{A} and LSF_{B} in this figure are obtained by y-direction projection of the pupil intensity distributions shown in FIGS. 14A and 14B, respectively. A horizontal axis corresponds to the x axis in FIGS. 14A and 14B, and a vertical axis shows intensity of the line spread function. As understood from an expression shown in FIG. 15, as an exit pupil distance (a distance from an image plane to the exit pupil) Dₚ decreases, the aperture diameter (aperture stop frame) D decreases, and thereby the area Areal becomes narrower. In the expression shown in FIG. 15, F represents an F-number (aperture value).

As understood from comparison of FIGS. 6C, 13C and 14C, a line image is changed according to the size, the exit pupil distance and the image height of the exit pupil (aperture stop frame), so that the shading is also changed according thereto. Thus, it is necessary to calculate the shading correction value, which is the correction parameter, according to the change of the shading.

Clipping data of the pupil intensity distribution in consideration of the lens information enables calculation of the shading correction value for each focus detection pixel from the clipped data of the pupil intensity distribution. This embodiment calculates, in order to meet various types of image taking lenses, the shading correction values for various image heights by using information on the modeled aperture stop frame D that is calculated from the aperture value F and the exit pupil distance Dₚ as shown in FIG. 15. The shading correction value may be calculated, if necessary, by using data of a frame to clip the pupil intensity distribution, the data of the frame being calculated in strict consideration of the lens information of each individual image taking lens.

As described above, the shading correction value is changed according to the image height. However, storing the shading correction values for all image heights even at a certain number of representative points to a memory makes a data quantity enormous. On the other hand, reducing a sampling number of the image height to reduce the data quantity may deteriorate focus detection accuracy.

In order to reduce the data quantity while acquiring good focus detection accuracy, this embodiment preliminarily calculates the shading correction value to be used for all the focus detection areas, and performs approximation with the following two-dimensional third-order polynomial approximate expression (1) where X and Y are coordinates of the focus detection area. Coefficients (shading coefficients) a, b, c, d, e and f of the respective terms are stored in a memory.

F=a+b·X+c·X²+d·Y²+e·X³+f·X·Y² (1)

The pupil intensity distribution has a symmetrical shape in a direction of Y, so that the expression (1) includes no odd-order term for Y. This also makes it possible to reduce the data quantity to be stored to the memory.

The shading coefficients are changed according to the aperture value and the exit pupil distance. Therefore, this embodiment calculates the shading coefficients a, b, c, d, e and f by a number of combinations of the aperture value and the exit pupil distance, and produces a data table of the shading correction values. The exit pupil distance may be decided by setting several reference points in a required range (for example, 50 mm to 300 mm) for the exit pupil distance and by employing a value for one reference point closest to an actual exit pupil distance. Moreover, the exit pupil distance may be calculated by interpolation from the values for the reference points.

### (Focus Detection Process Including Correction Process)

Next, description will be made of a focus detection process in this embodiment. Also in this embodiment, as in Embodiment 1, one of the operation of the focus detection area selection button 205 shown in FIG. 9 and the selection process of the CPU 121 selects the position of the focus detection area where the focus detection is actually performed among the multiple focus detection areas provided over the entire image capturing area. Moreover, as in Embodiment 1, the focus detection area where the focus detection is actually performed can be selected from the minimum unit area (one focus detection area) and the extended area (plural focus detection areas) through the operation of the focus detection area selection button 205.

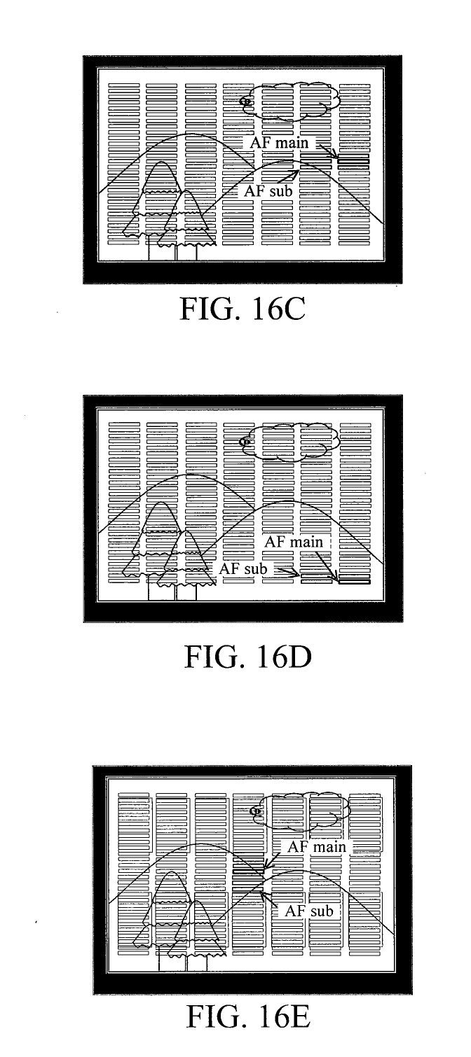

When the minimum unit area is selected, one focus detection area AFmain selected in response to the operation of the focus detection area selection button 205 or by the selection process of the CPU 121 is set as the focus detection area where the focus detection is actually performed, as shown in FIG. 16A. On the other hand, when the extended area is selected, the above-mentioned selected one focus detection area AFmain and plural (two or more) focus detection areas AFsub adjacent to the focus detection area AFmain (that is, arranged around the focus detection area AFmain) are set as the focus detection areas where the focus detection is actually performed, as shown in FIG. 16B.

When the extended area is selected, the focus detection area AFmain corresponds to the first focus detection area, and the focus detection areas AFsub, which are arranged in a predetermined close area to the focus detection area AFmain (adjacent area thereto or surrounding area), corresponds to the second focus detection area. FIG. 16B shows an example of a case where the focus detection area AFmain located at the center of the image capturing area and eight surrounding focus detection areas AFsub are selected. As in Embodiment 1, the mode in which the focus detection is performed in the minimum unit area is referred to as “the minimum unit area focus detection mode”, and the mode in which the focus detection is performed in the extended area is referred to as “the extended area focus detection mode”.

Similarly to Embodiment 1, this embodiment uses, in the extended area focus detection mode, the correction parameters (shading correction value and distortion correction value) for the image signals obtained in the focus detection area AFmain also as correction parameters for the image signals obtained in the focus detection area AFsub.

Next, description will be made of the focus detection process (a control method for the image pickup apparatus) including the correction process with reference to the flowcharts shown in FIGS. 11 and 12 used in Embodiment 1, the process being executed by the CPU 121 according to a computer program as a focus detection program.

First of all, description will be made of the focus detection process in the minimum unit area focus detection mode with reference to the flowchart shown in FIG. 11.

At step S001, the CPU 121 produces the paired image signals ImgA and ImgB by using the output signals from the focus detection pixels corresponding to the focus detection area AFmain selected in response to the operation of focus detection area selection button 205 or by the selection process of the CPU 121.

At step S002, the CPU 121 calculates the shading correction value and the distortion correction value that are the correction parameters (first correction parameters) to be used in shading correction for the paired image signals ImgA and ImgB.

Specifically, the CPU 121 first acquires the lens information necessary to confirm the vignetting state of the light flux due to the image taking lens from the image taking lens. The lens information (that is, the information on the vignetting state) includes the same information as that described in Embodiment 1. The definition of the “acquisition of the lens information” is same as that described in Embodiment 1.

The CPU 121 predicts a vignetting state of the paired image signals ImgA and ImgB produced at step S001 by using the acquired lens information and the pupil intensity distribution for each focus detection pixel stored in the ROM of the CPU 121. Then, the CPU 121 calculates the shading correction value for correcting the shading of the paired image signals ImgA and ImgB.

Moreover, the CPU 121 calculates the phase difference between the paired image signals ImgA and ImgB produced at step S001, and calculates a provisional defocus amount on the basis of the phase difference. In addition, the CPU 121 calculates the distortion correction value that is the correction parameter for correcting the distortion of the paired image signals ImgA and ImgB by using the provisional defocus amount, the lens information and the pupil intensity distribution. Thus, the correction parameters for the focus detection area AFmain corresponding to the vignetting state of the light flux in the focus detection area AFmain due to the image taking lens (image taking optical system) are calculated.

Next, at step S003, the CPU 121 performs the correction process on the paired image signals ImgA and ImgB produced at step S001, by using the correction parameters calculated at step S002.

Specifically, the CPU 121 first performs the shading correction using the shading correction value on the image signals ImgA and ImgB to produce (calculate) shading corrected image signals ImgA′ and ImgB′. Thereafter, the CPU 121 performs the distortion correction using the distortion correction value on the shading corrected image signals ImgA′ and ImgB′ to produce (calculate) distortion corrected image signals ImgA″ and ImgB″.

Next, at step S004, the CPU 121 performs the correlation calculation on the distortion corrected image signals ImgA″ and ImgB″ produced at step S003 to calculate the phase difference therebetween. Then, the CPU 121 calculates the defocus amount of the image taking lens on the basis of the phase difference. Thus, the focus detection process is ended.

The CPU 121 calculates, from the calculated defocus amount, a movement amount of the third lens group 105 to obtain an in-focus state, and then drives the focus actuator 114 to move the third lens group 105 by the calculated movement amount. Thus, autofocus (AF) is completed.

Next, description will be made of the focus detection process when the extended area focus detection mode is selected, with reference to the flowchart shown in FIG. 12.

At step S101, the CPU 121 selects the focus detection area AFmain in response to the operation of the focus detection area selection button 205 or by the process of the CPU 121, and then selects the plural surrounding focus detection areas AFsub. The number of the selected focus detection areas AFsub is changed according to the position of the focus detection area AFmain. For example, when the focus detection area AFmain is located at the vicinity of the center of the image capturing area as shown in FIG. 16B, the number of the focus detection areas AFsub is eight. When the focus detection area AFmain is located at an edge of the image capturing area as shown in FIG. 16C, the number of the focus detection areas AFsub is five. In addition, when the focus detection area AFmain is located at a corner of the image capturing area as shown in FIG. 16D, the number of the focus detection areas AFsub is three. However, the method of selecting the focus detection areas AFsub is not limited to the above-mentioned one, for example, only the focus detection areas AFsub located above and below the focus detection area AFmain may be selected as shown in FIG. 16E.

At step S102, the CPU 121 produces the paired image signals ImgA and ImgB by using the output signals from the focus detection pixels corresponding to one focus detection area among the focus detection areas AFmain and AFsub.

At step S103, the CPU 121 determines whether the focus detection area in which the paired image signals ImgA and ImgB have been produced at step S102 is the focus detection area AFmain or the focus detection area AFsub. If determining that the focus detection area in which the paired image signals ImgA and ImgB have been produced is the focus detection area AFmain, the CPU 121 proceeds to step S104 (parameter calculating step). At step S104, the CPU 121 calculates the correction parameters (shading correction value and distortion correction value) for performing the shading correction and the distortion correction on the paired image signals ImgA and ImgB obtained in the focus detection area AFmain. The correction parameters are calculated by the same method as that described at step S002 in FIG. 11.

Specifically, the CPU 121 first acquires the lens information necessary to confirm the vignetting state of the light flux due to the image taking lens from the image taking lens. Next, the CPU 121 predicts the vignetting state of the paired image signals ImgA and ImgB produced at step S102 by using the lens information and the pupil intensity distribution for each focus detection pixel stored in the ROM of the CPU 121. Then, the CPU 121 calculates the shading correction value that is the correction parameter for correcting the shading of the paired image signals ImgA and ImgB.

Next, the CPU 121 calculates the phase difference between the paired image signals ImgA and ImgB produced at step S102, and calculates a provisional defocus amount on the basis of the phase difference. In addition, the CPU 121 calculates the distortion correction value that is the correction parameter for correcting the distortion of the paired image signals ImgA and ImgB by using the provisional defocus amount, the lens information and the pupil intensity distribution. Thus, the correction parameters for the focus detection area AFmain corresponding to the vignetting state of the light flux in the focus detection area AFmain due to the image taking lens (image taking optical system) are calculated.

On the other hand, if determining that the focus detection area in which the paired image signals ImgA and ImgB have been produced is the focus detection area AFsub at step S103, the CPU 121 proceeds to step S105. At step S105, the CPU 121 acquires the correction parameters (shading correction value and distortion correction value) calculated at step S104 for the focus detection area AFmain. In other words, the correction parameters for the focus detection area AFmain is used as the correction parameters for the focus detection area AFsub without calculating the correction parameters for the focus detection area AFsub. This is because the focus detection area AFsub is adjacent to the focus detection area AFmain, and therefore a difference between the vignetting states due to the image taking lens in the focus detection area AFsub and the focus detection area AFmain is generally small.

At step S106, the CPU 121 performs the correction process on the paired image signals ImgA and ImgB produced at step S102, by using the correction parameters calculated at step S104 or obtained at step S105. Specifically, the CPU 121 performs the same correction process as that described at step S003 in FIG. 11 on the paired image signals ImgA and ImgB to produce (calculate) the shading corrected image signals ImgA′ and ImgB′, and then to produce (calculate) the distortion corrected image signals ImgA″ and ImgB″.

Next, at step S107, the CPU 121 performs the correlation calculation on the distortion corrected image signals ImgA″ and ImgB″ produced at step S106 to calculate the phase difference therebetween. Thereafter, the CPU 121 calculates the defocus amount of the image taking lens on the basis of the phase difference.

Next, at step S108, the CPU 121 determines whether or not the focus detection has finished in the focus detection area AFmain and all of the plural focus detection areas AFsub. If determining that the focus detection in all of the focus detection areas AFmain and AFsub has not finished yet, the CPU 121 returns to step S102 to perform the focus detection in the focus detection area where the focus detection has not finished yet. If determining that the focus detection in all of the focus detection areas AFmain and AFsub has finished, the CPU 121 ends the focus detection process.

The CPU 121 calculates the movement amount of the third lens group 105 to obtain an in-focus state from the calculated defocus amount, and then drives the focus actuator 114 to move the third lens group 105 by the calculated movement amount. Thus, the autofocus is completed.

As described above, each of Embodiments 1 and 2 uses, when the extended area focus detection mode is selected, the correction parameters calculated for the focus detection area AFmain also for the plural focus detection areas AFsub located in the predetermined close area to the focus detection area AFmain. Such shared use of the correction parameters makes it possible to eliminate the calculation of the correction parameters for the plural focus detection areas AFsub, which enables reduction of calculation amount.

Moreover, it is not necessary for a lens-interchangeable image pickup apparatus to acquire the lens information used in calculation of the correction parameters for the plural focus detection areas AFsub from the image taking lens (optical apparatus) through communication therewith, which enables reduction of the number of times of communication, and thereby enables reduction of time required for simultaneous focus detection in the focus detection areas AFmain and AFsub.

Each of Embodiments 1 and 2 has described about the shared use of the correction parameters, which is calculated for the focus detection area AFmain, for the focus detection areas AFmain and AFsub on the basis of a premise that the difference between the vignetting states due to the image taking lens in the focus detection areas AFmain and AFsub is small. However, in a case where the difference between the vignetting states due to the image taking lens in the focus detection areas AFmain and AFsub is large, such shared use of the correction parameters is impossible.

Thus, in this case, an alternative embodiment may determine the difference between the vignetting states in the focus detection areas AFmain and AFsub. Then, if the difference is smaller than a predetermined value, the correction parameters may be shared, and if the difference is greater than the predetermined value, correction parameters dedicated for the focus detection area AFsub may be calculated. In other words, whether to perform the correction process for the focus detection area AFsub with the correction parameters calculated for the focus detection areas AFmain or not may be selected according to the vignetting state due to the image taking lens.

Moreover, each of Embodiments 1 and 2 has described the case where the correction process is performed on both the paired image signals ImgA and ImgB. However, the correction process may be performed on at least one of the paired image signals ImgA and ImgB as long as a good correlation calculation result (a high degree of coincident of the image signals) can be obtained.

Furthermore, each of Embodiments 1 and 2 has described the case where only one focus detection area AFmain is selected in the minimum unit area focus detection mode and the extended area focus detection mode. However, plural focus detection areas AFmain may be selected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-276591, filed on Dec. 13, 2010, and 2011-255571, filed on Nov. 22, 2011 which are hereby incorporated by reference herein in their entirety.

What is claimed is:

1. An image pickup apparatus comprising:
an image sensor configured to include first pixels and second pixels that respectively photoelectrically convert light fluxes passing through mutually different pupil areas of an exit pupil of an image taking optical system;
a correction calculating part configured to calculate a correction parameter corresponding to a vignetting state of the light fluxes subjected to vignetting due to the image taking optical system, and configured to perform a correction process using the correction parameter on at least one of a first image signal produced from outputs from the first pixels and a second image signal produced from outputs from the second pixels; and
a focus detection calculating part configured to calculate a focus state of the image taking optical system based on a phase difference between the first and second image signals on the at least one of which the correction process has been performed by the correction calculating part,
wherein the focus detection calculating part is configured to calculate the focus state in a first focus detection area selected from plural focus detection areas provided in an image capturing area, and configured to calculate the focus state in a second focus detection area included in a predetermined close area to the first focus detection area, and
wherein the correction calculating part is configured to calculate a first correction parameter that is the correction parameter corresponding to the vignetting state in the first focus detection area, configured to perform the correction process using the first correction parameter in the first focus detection area, and configured to perform the correction process using the first correction parameter in the second focus detection area.

2. An image pickup apparatus according to claim 1, wherein the correction calculating part is configured to select, depending on the vignetting state, whether or not to perform the correction processing using the first parameter in the second focus detection area.

3. An image pickup apparatus according to claim 1,
wherein the image pickup apparatus is configured such that an optical apparatus including the image taking optical system is detachably attachable thereto, and configured to be capable of communicating with the attached optical apparatus, and
wherein the correction calculating part is configured to acquire information on the vignetting state from the optical apparatus to calculate the correction parameter.

4. An image pickup apparatus according to claim 1,
wherein the correction parameter is used for correcting any of signal level lowering, distortion and shading of the at least one of the first and second image signals generated corresponding to the vignetting state.

5. A method for controlling an image pickup apparatus provided with an image sensor configured to include first pixels and second pixels that respectively photoelectrically convert light fluxes passing through mutually different pupil areas of an exit pupil of an image taking optical system, the method comprising:
a parameter calculating step of calculating a correction parameter corresponding to a vignetting state of the light fluxes subjected to vignetting due to the image taking optical system;
a correction calculating step of performing a correction process using the correction parameter on at least one of a first image signal produced from outputs from the first pixels and a second image signal produced from outputs from the second pixels; and
a focus detection calculating step of calculating a focus state of the image taking optical system based on a phase difference between the first and second image signals on the at least one of which the correction process has been performed in the correction calculating step,
wherein, in the focus detection calculating step, the method calculates the focus state in a first focus detection area selected from plural focus detection areas provided in an image capturing area, and calculates the focus state in a second focus detection area included in a predetermined close area to the first focus detection area, and
wherein, in the correction calculating step, the method calculates a first correction parameter that is the correction parameter corresponding to the vignetting state in the first focus detection area, performs the correction process using the first correction parameter in the first focus detection area, and performs the correction process using the first correction parameter in the second focus detection area.
